(19) United States
(12) Patent Application Publication
(10) Pub. No.: US 2008/0000096 A1
(43) Pub. Date: Jan. 3, 2008

(54) Stake line adjusting and layout system

(76) Inventor: Thomas Wade, Blue Earth, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/647,523

(22) Filed: Dec. 28, 2006

Related U.S. Application Data
(63) Continuation-in-part of application No. 11/545,709, filed on Oct. 10, 2006.
(60) Provisional application No. 60/725,122, filed on Oct. 11, 2005.

(51) Int. Cl. G01C 15/00

(52) U.S. Cl. 33/404

(57) ABSTRACT

An adjusting device having a front plate and a stabilizing bracket extending generally transversely from the front plate. An adjusting slot, a centerline slot, and a plurality of lateral slots are defined in the front plate. The stabilizing bracket extends generally transversely from the front plate. The device is affixed to a horizontal member and may be horizontally adjusted on the horizontal member to determine the location of a string, the string determining the outer boundary of a footing to be poured. It is emphasized that this abstract is provided to comply with the rules requiring an abstract that will allow a searcher or other reader to quickly ascertain the subject matter of the technical disclosure.

### CROSS-REFERENCES TO RELATED APPLICATIONS

This application is a continuation-in-part of U.S. patent application Ser. No. 11/545,709, filed 10 Oct. 2006, which in turn claims priority under 35 U.S.C. § 119 (e) to U.S. Provisional Application No. 60/725,122, filed 11 Oct. 2005, each hereby incorporated by reference.

### BACKGROUND OF THE INVENTION

1. Field of the Invention

This invention relates to construction implements and, in particular, this invention relates to construction implements for laying out the footings of structures such as buildings.

2. Background

Referring to FIGS. 1 and 2, the boundaries for construction components, such as footings, are determined by erecting batter boards outside what will become outer boundaries of the footings. An exemplary batter board is depicted in FIG. 3 generally at 100 and has vertical members 102 and 104 and a horizontal member 106. However, several types of batter boards are known to the art. The vertical members of the embodiment shown are indicated at 102 and 104 and are affixed to the horizontal member 106 by connectors, such as nails, screws, staples, glue, or the like. In the embodiment depicted, the vertical members extend generally perpendicularly to the horizontal member. The batter board 100 is pounded into the ground sufficiently to support the strings depicted in FIGS. 1 and 2, when tension is applied to the strings. These strings are attached so as to be disposed vertically above the outer dimensions of the footing to be dug and poured. The strings are attached to the horizontal member 106 of each batter board by driving a connector, such as a nail or a screw, into an upper surface of the horizontal member, then knotting the string to the connector. The strings, as attached thusly, must then be verified that they are “square,” that is adjoining strings are perpendicularly disposed with respect to each other. Verification involves measuring the distances A-B and C-D and diagonals A-D and B-C. If the strings are square, the lengths A-B and C-D will be equal the diagonals A-D and B-C will be equal as well. Often, the first attempt at placing the strings will not result in the square corners required. Subsequently, the strings must be horizontally adjusted on the horizontal members of the batter boards. Horizontal adjustment requires that the connector be removed from the horizontal member, then moved laterally or horizontally to a new position, then affixed to the horizontal member again. The procedure described above is then repeated until the lengths of the distances and diagonals are equal, within acceptable tolerances. As stated above, this procedure involves removing connectors, laterally adjusting the removed connector, then extending the connector into the horizontal member. This is difficult, time consuming, hence inefficient.

There is then a need for a device not requiring connectors to horizontally adjust outer boundaries of footings, when the footings are being determined.

### SUMMARY OF THE INVENTION

This invention substantially meets the aforementioned needs of the industry by providing a device for horizontally determining the dimension of a footing. The device may include a front plate and a stabilizing bracket. The front plate may comprise an adjustment/mounting slot, a centerline slot, and a pair of generally oppositely disposed lateral slots. A plurality of front grips may be disposed on the front plate. The front plate may include a base and an upper portion.

The lateral slots may be defined between an upper surface of the base and a lower surface of the upper portion.

A method of manufacturing an adjusting device is also provided. The method may include forming a front plate and a stabilizing bracket, wherein an adjustment groove, a centerline slot, and a pair of oppositely disposed lateral slots are defined in the front plate. The stabilizing bracket may extend generally transversely from the front plate.

A method of determining an outer boundary of a footing is also provided. The method may include attaching an adjusting device to a horizontal member; attaching a string to a horizontal connector; horizontally displacing said adjusting device; and horizontally securing said adjusting device when the outer boundary has been determined. The adjusting device may be attached to a horizontal member, e.g., of a batter board, by extending a connector through a slot defined in the adjusting device and into the horizontal member. The horizontal connector may be attached to a string by disposing the string in a centerline slot and wrapping the string through a pair of lateral slots defined in the adjusting device.

These and other objects, features, and advantages of this invention will become apparent from the description which follows, when considered in view of the accompanying drawings.

### BRIEF DESCRIPTION OF THE DRAWINGS

FIG. 1 is a perspective view of a procedure for deploying check strings to determine the outer boundaries of a footing to be poured;

FIG. 2 is a perspective drawing of the final step of the procedure depicted in FIG. 1;

FIG. 3 is a plan view of one embodiment of a batter board used with the adjusting device of this invention;

FIG. 4 is a front plan view of one embodiment of the adjusting device of this invention;

FIG. 5 is a bottom view of the adjusting device shown in FIG. 4;

FIG. 6 is a side view of the adjusting device shown in FIG. 4;

FIG. 7 is a perspective view of the adjusting device shown in FIG. 4; and

FIG. 8 is a perspective view of the adjusting device of this invention being used to determine a boundary of a footing to be poured.

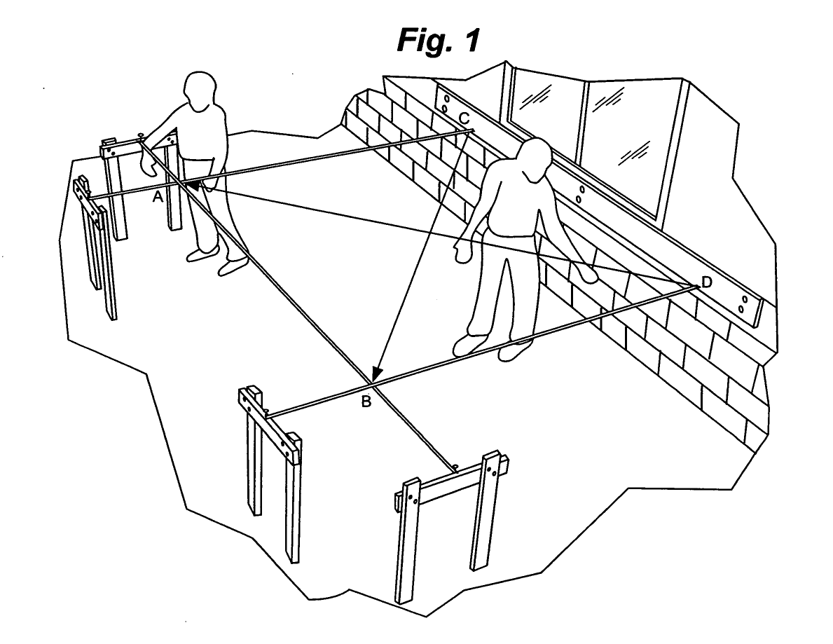

It is understood that the above-described figures are only illustrative of the present invention and are not contemplated to limit the scope thereof.

### DETAILED DESCRIPTION

Any references to such relative terms as front and back, top and bottom, upper and lower, horizontal and vertical, or the like, are intended for convenience of description and are not intended to limit the present invention or its components to any one positional or spatial orientation. All dimensions and relative angles of the components in the attached figures may vary with a potential design and the intended use of an embodiment of the invention without departing from the scope of the invention.

A representative example of the teachings of the present invention, which utilizes many of these additional features and methods in conjunction, will now be described in detail with reference to the drawings. This detailed description is merely intended to teach a person of skill in the art further details for practicing preferred aspects of the present teachings and is not intended to limit the scope of the invention. Therefore, combinations of features and methods disclosed in the following detailed description may not be necessary to practice the invention in the broadest sense and are instead taught merely to particularly describe representative and preferred embodiments of the invention.

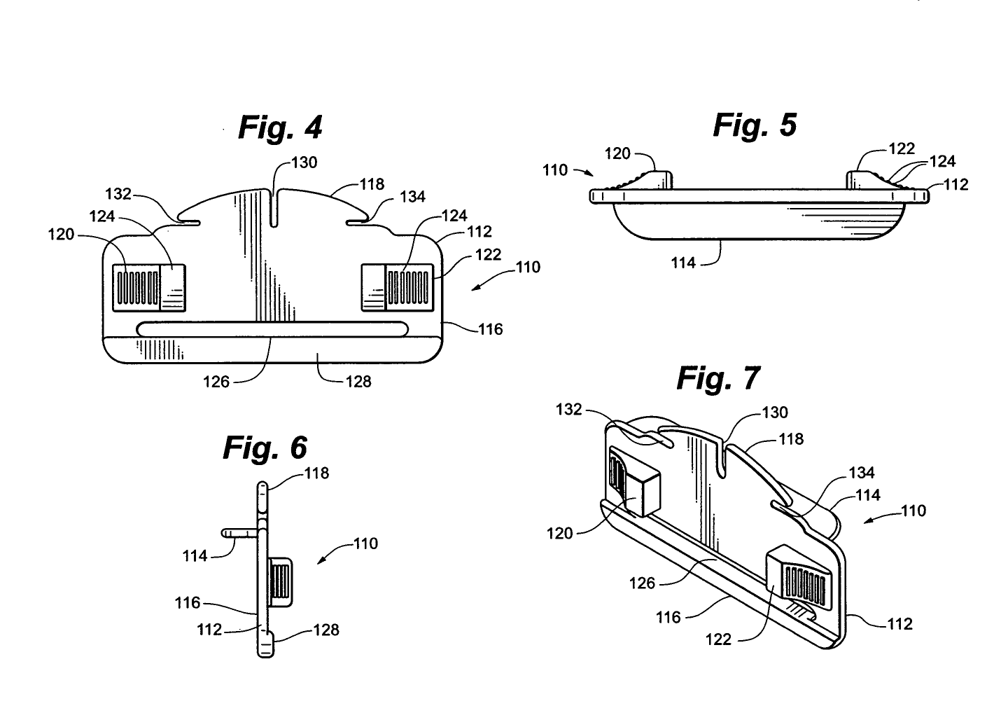

Referring to FIGS. 4-7, one embodiment of the adjusting device of this invention is depicted generally at 110 and has a front plate 112 and a stabilizing bracket 114. In the embodiment depicted, the front plate has a generally rectangular lower base 116, which is unitarily, or otherwise integrally, joined to a generally elliptical upper portion 118. A plurality, e.g., a pair, of gripping devices such as grips 120 and 122 may optionally extend from a front surface of the base 116. As shown, the grips 120 and 122 may be sloped to present a tapering profile and may have gripping aids, such as grooves 124. However, a person of ordinary skill in the art would readily comprehend that the grips 120 and 122 may be absent or may be substituted by other gripping surfaces, such as grooves defined in the face of the base 116. An adjustment/mounting slot 126 is formed in the base 116. In the embodiment shown, the slot 126 is generally parallel to the stabilizing bracket 114. A lip 128 may be defined in a lower portion of the base 116, such that an upper edge of the lip 128 defines a lower portion of the slot 126. The lip 128 may have a greater cross sectional dimension than the remainder of the front plate 112. In the embodiment depicted, the slot 126 is defined in a lower portion of the base 116 and is generally parallel to the lower edge of the base. A centerline slot 130 is defined in the upper portion 118, e.g., generally centrally in the upper portion 118. In the embodiment depicted, the centerline slot 130 extends generally perpendicularly to the adjustment/mounting slot 126. A plurality, e.g., a pair, of lateral slots 132 and 134 are defined between lower edges of the upper portion 118 and upper edges of the base 116. The lateral slots 132 and 134 function as friction locks, their function described more fully below. The stabilizing bracket 114 extends generally perpendicularly, or otherwise transversely, from the front plate 112 in the embodiment depicted. A person of ordinary skill in the art will readily recognize that a plurality of members extending from the front plate would be used in place of the single stabilizing bracket shown.

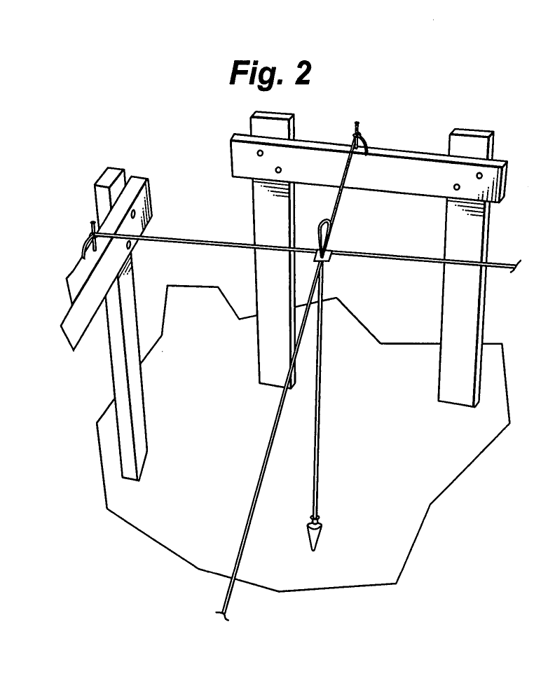

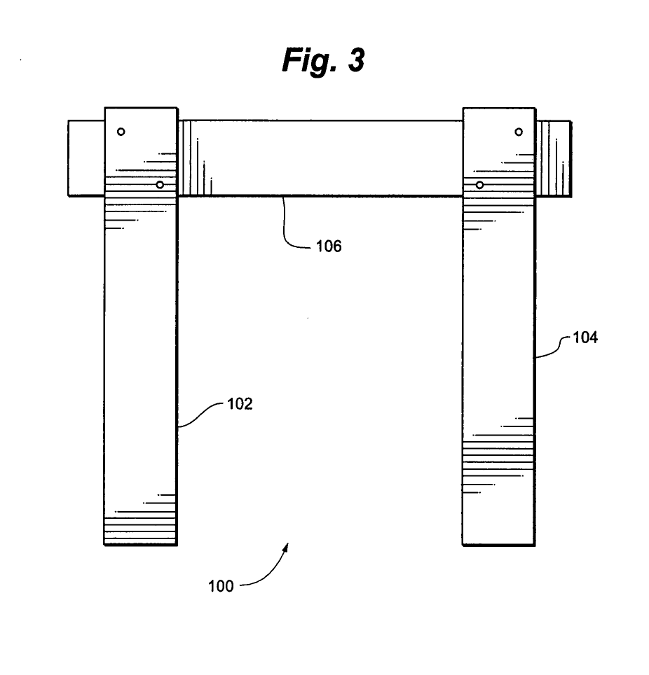

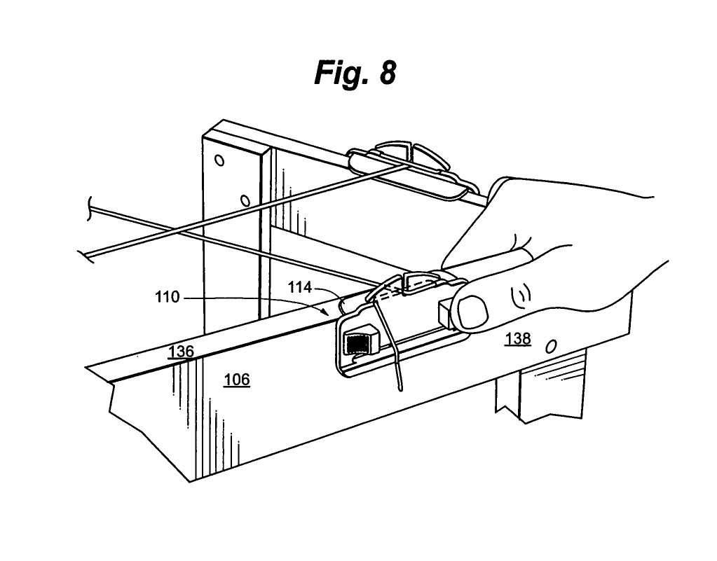

In use, the adjusting device 110 is attached to a horizontal member 106 of a batter board, then horizontally adjusted as follows. A bottom surface of the stabilizer bracket 114 contacts an upper edge 136 of the horizontal member 106 and the base 116 contacts the outer surface 138 of the horizontal member 106. The adjusting device 110 is then slid horizontally to a desired position on the horizontal member 106. A connector, such as a screw 140, is then inserted through the slot 126 and into the horizontal member 106 and tightened so that the adjusting device 110 may be horizontally displaced, but will hold the string securely during adjustment. A string to be used in determining the outer boundaries and corners of the footing is then passed through centerline slot 130, then looped through the lateral slots 132 and 134, which thereby function as a friction securing lock. The lengths of the segments A-B and C-D and diagonals A-D and B-C are then determined. If the segments A-B and C-D are not equal and the diagonals A-D and B-C are not equal, the strings are horizontally adjusted by a user's thumb displacing the adjusting device, as shown in FIG. 8. The segments and diagonals are then re-measured. The positions of the strings are then horizontally adjusted again. Measurement and adjustment continues until the lengths of the segments and diagonals are within tolerances. Then, the screw 140 is further tightened to secure the adjusting device 110 and string in place. As can be seen from FIG. 2, the positions of the corners of the footing are then determined by holding a string attached to a plumb bob next to the intersection of the adjusted strings, then releasing the string and allowing the plumb bob to strike the position where the footing corner has been determined.

The device of this invention may be made of any material with sufficient rigidity to be attached and adjusted as shown herein. Materials suitable for certain embodiments include synthetic resins, metals, wood, and the like. Suitable synthetic resins include polycarbonate, polyethylene and polypropylene. However, a person of ordinary skill in the art will readily recognize that other synthetic resins may be suitable for a given embodiment of this invention. Other suitable synthetic resins may be found in the Handbook of Plastics, Elastomers, and Composites, Charles A. Harper, Editor in Chief, Third Edition, McGraw-Hill, New York, 1996, hereby incorporated by reference. Suitable metals include steel alloys, aluminum, stainless steel, iron, and the like.

A person of ordinary skill in the art will readily appreciate that individual components shown on various embodiments of the present invention are interchangeable to some extent and may be added or interchanged on other embodiments without departing from the spirit and scope of this invention.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. A device for horizontally determining a dimension of a footing, the device comprising:
a front plate comprising an adjustment/mounting slot, a centerline slot, and means for friction locking string attached to said front plate; and
a stabilizing bracket extending generally transversely from the front plate.

2. The device of claim 1, further comprising a plurality of thumb grips disposed on the front plate.

3. The device of claim 1, wherein said stabilizing bracket extends generally perpendicularly from the front plate.

4. The device of claim 1, wherein said friction locking means comprises a plurality of generally oppositely defined slots.

5. The device of claim 4, the front plate comprising a base and an upper portion and in which said oppositely defined slots are defined between said base and said upper portion.

6. The device of claim 1, in which the centerline slot is generally parallel to the stabilizing bracket.

7. The device of claim 1, in which the front plate further comprises a lip positioned below the slot.

8. The device of claim 7, in which the lip has a greater cross sectional dimension than a remaining portion of the front plate.

9. The device of claim 7, in which the lip forms a lower portion of the slot.

10. A method of manufacturing an adjusting device, the method comprising forming a front plate and a stabilizing bracket, an adjustment groove, a centerline slot, and a pair of oppositely disposed letter of slots defined in the front plate, the stabilizing bracket extending generally transversely from the front plate.

11. The method of claim 10, in which the adjusting device is manufactured from a synthetic resin, wood, or a metal alloy.

12. The method of claim 10, in which the adjusting device is manufactured from a synthetic resin.

13. A method of determining an outer boundary of a footing, the method comprising:
attaching an adjusting device to a horizontal member by extending a connector through a slot defined in the attachment device and into the horizontal member;
attaching a string to the horizontal connector by disposing the string in a centerline slot and a pair of lateral slots;
horizontally displacing said adjusting device to adjust the position of the string; and
horizontally securing said adjusting device when the string is in a desired position.

14. The method of claim 13, in which the adjusting device is attached to the horizontal member so that a front plate of the adjusting device contacts a vertical surface of the horizontal member and so that a stabilizing bracket contacts a horizontal surface of the horizontal member.

15. The method of claim 14, in which the stabilizing bracket contacts an upper surface of the horizontal member.

16. The method of claim 13, in which the string is a member of a string geometry and in which the string is in a desired position when opposing diagonals extending from opposite corners of the string geometry are substantially equal.

17. The method of claim 16, in which the string geometry is a rectangle.

18. The method of claim 13, in which the adjusting device is horizontally displaced such that the connector is horizontally displaced within said slot.

19. The method of claim 13, in which said connector includes a screw and in which said screw is rotated to secure said adjusting device in said desired position.

20. The method of claim 13, in which said horizontal member comprises a batter board and in which said batter board is fixed outside the outer boundary of said footing.
